(19) United States
(12) Patent Application Publication
(10) Pub. No.: US 2009/0150142 A1
(43) Pub. Date: Jun. 11, 2009

(54) BEHAVIOR DETERMINATION APPARATUS AND METHOD, BEHAVIOR LEARNING APPARATUS AND METHOD, ROBOT APPARATUS, AND MEDIUM RECORDED WITH PROGRAM

(75) Inventors: Haeyeon LEE, Toyota-shi (JP); Tetsunari INAMURA, Miura-shi (JP); Masayuki INABA, Kamagaya-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/329,252

(22) Filed: Dec. 5, 2008

(30) Foreign Application Priority Data
Dec. 7, 2007 (JP) 2007-317453

(51) Int. Cl. G06F 17/27

(52) U.S. Cl. 704/9; 901/50; 901/1

(57) ABSTRACT

A robot includes a knowledge acquisition unit for extracting words from external instruction information, a network construction unit for constructing a network from the extracted words and updating weightings between the words, and a behavior determination unit for determining a behavior on the basis of a word network in which relationships between the words are weighted on a network.

### INCORPORATION BY REFERENCE

The disclosure of Japanese Patent Application No. 2007-317453 filed on Dec. 7, 2007 including the specification, drawings and abstract is incorporated herein by reference in its entirety.

### BACKGROUND OF THE INVENTION

1. Field of the Invention

The invention relates to a behavior determination apparatus and method, a behavior learning apparatus and method, a robot apparatus, and a medium recorded with a program, and more particularly to a behavior determination apparatus and method, a behavior learning apparatus and method, and a medium recorded with a program that are suitable for installation in a robot apparatus capable of autonomous action, and to a robot apparatus installed therewith.

2. Description of the Related Art

A technique in which actions are modeled and stored as action models and a subsequent action is determined from an action model based on past experience is available as a conventional method for determining an action of a robot (see Japanese Patent Application Publication No. 2005-297105 (JP-A-2005-297105), for example).

The robot apparatus described in JP-A-2005-297105 includes state input means for inputting an external or internal state of the robot apparatus, internal state managing means for managing internal state vectors, associative storage means for calculating a predicted internal state variation vector on the basis of a state vector corresponding to the external or internal state, and information generating means for generating information relating to the robot apparatus on the basis of a current internal state vector managed by the internal state managing means and the predicted internal state variation vector calculated by the associative storage means.

The associative storage means is formed from a neural network having a state vector, which is constituted by a person ID obtained from a face/person recognition device, an object ID obtained from an object recognition device, other information from various sensors, and so on, as input and the predicted internal state variation vector as output, and learns a set of the state vector and the actual internal state variation vector at that time as a learning sample. When a similar state vector is obtained, a predicted internal state variation vector based on past experience is supplied to the emotion generating means from the associative storage means. The emotion generating means generates an emotion on the basis of the predicted internal state variation vector and the internal state vector. Behavior selecting means selects an action corresponding to the emotion.

However, with the technique described in JP-A-2005-297105, only behavior within the range of the stored action models can be generated. A target of the related art is to generate robot movement that corresponds to the surrounding conditions. Therefore, the focus of the related art has been directed toward experience extraction, in which an identical taught movement is performed under identical conditions to those of the past, rather than task execution.

More specifically, in the intelligence storage space of the robot (machine) according to the related art, only determined actions are performed in relation to limited information, such as environmental variation caused by a movement of the robot itself and behavior to be taken in relation to static object information. However, a technique enabling an autonomous robot to classify and associate large amounts of information obtained over time is required. If this information can be modularized and gathered in a single information space, an action (reaction) employing complicated information can be generated.

### SUMMARY OF THE INVENTION

The invention provides a behavior learning apparatus and method capable of constructing an intelligent determination system in which input information is modularized into a single information space, a behavior determination apparatus and method using a learning result generated by the behavior learning apparatus, a robot apparatus installed with these apparatuses, and a medium recorded with a program.

A behavior determination apparatus according to a first aspect of the invention includes: a word extraction unit for extracting words from external instruction information; and a behavior determination unit for determining a behavior on the basis of a word network in which relationships between words are weighted on a network, and the words extracted by the word extraction unit.

In the first aspect of the invention, a behavior is determined on the basis of the word network, in which relationships between words are weighted on a network, and therefore an action constituted by words having a close relationship to the external instruction information can be determined.

A behavior learning apparatus according to a second aspect of the invention includes: a word extraction unit for extracting words from external instruction information; and a network construction unit for constructing a network in which words are associated by weightings on the basis of the words extracted by the word extraction unit and relationships therebetween, and updating the weightings between the words on the basis of the instruction information.

In the second aspect of the invention, a network in which weightings between words are defined using external instruction information can be generated and learned.

A behavior determination method according to a third aspect of the invention includes: a word extraction step of extracting words from external instruction information; and a behavior determination step of determining a behavior on the basis of a word network in which relationships between words are weighted on a network, and the words extracted in the word extraction step.

A behavior learning method according to a fourth aspect of the invention includes: a word extraction step of extracting words from external instruction information; and a network construction step of constructing a network in which words are associated by weightings on the basis of the words extracted in the word extraction step and relationships therebetween, and updating the weightings between the words on the basis of the instruction information.

A robot apparatus according to a fifth aspect of the invention is a robot apparatus for expressing an action in accordance with an external instruction, including: a word extraction unit for extracting words from external instruction information; and a behavior determination unit for determining a behavior on the basis of a word network in which relationships between words are weighted on a network, and the words extracted by the word extraction unit.

Another robot apparatus according to a sixth aspect of the invention includes: a word extraction unit for extracting words from external instruction information; and a network construction unit for constructing a network in which words are associated by weightings on the basis of the words extracted by the word extraction unit and relationships therebetween, and updating the weightings between the words on the basis of the instruction information.

Further, in a medium recorded with a program for causing a computer to execute a predetermined operation according to seventh and eighth aspects of the invention, the program includes the behavior determination processing or the behavior learning processing described above.

According to the invention, a behavior learning apparatus and method capable of constructing an intelligent determination system in which input information is modularized into a single information space, a behavior determination apparatus and method using a learning result generated by the behavior learning apparatus, and a robot apparatus installed with these apparatuses can be provided.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a perspective view showing a bipedal walking robot according to an embodiment of the invention;

FIG. 2 is a block diagram showing the robot according to an embodiment of the invention;

FIG. 3 is a view showing a behavior determination apparatus according to an embodiment of the invention;

FIG. 4 is a view showing a word network according to an embodiment of the invention;

FIG. 5 is a flowchart showing a word network construction method according to an embodiment of the invention;

FIG. 6 is a flowchart showing a behavior determination method according to an embodiment of the invention; and

FIG. 7 is a view illustrating a method of using the word network according to an embodiment of the invention.

### DETAILED DESCRIPTION OF EMBODIMENTS

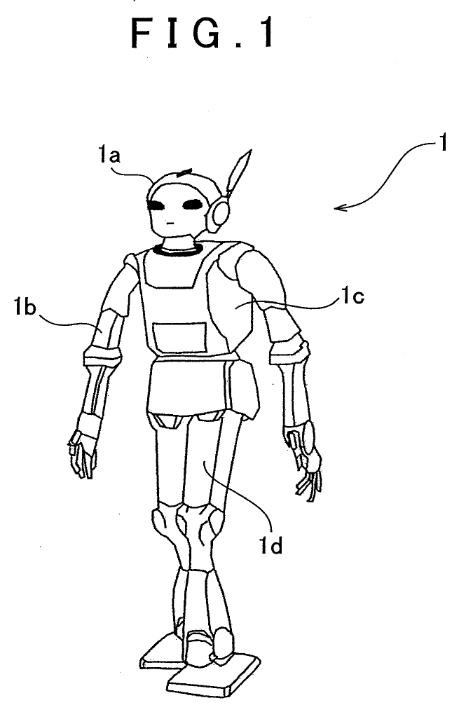

A specific embodiment to which the invention is applied will be described in detail below with reference to the drawings. FIG. 1 is a perspective view showing a bipedal walking robot according to an embodiment of the invention. As shown in FIG. 1, a robot 1 is formed by connecting a head portion unit 1a, left and right arm portion units 1b, and left and right leg portion units 1d to predetermined positions of a trunk portion unit 1c. Note that in this embodiment, a bipedal walking robot is used for descriptive purposes, but a quadruped walking robot, a robot having leg portions constituted by wheels or the like, and so on may be used instead.

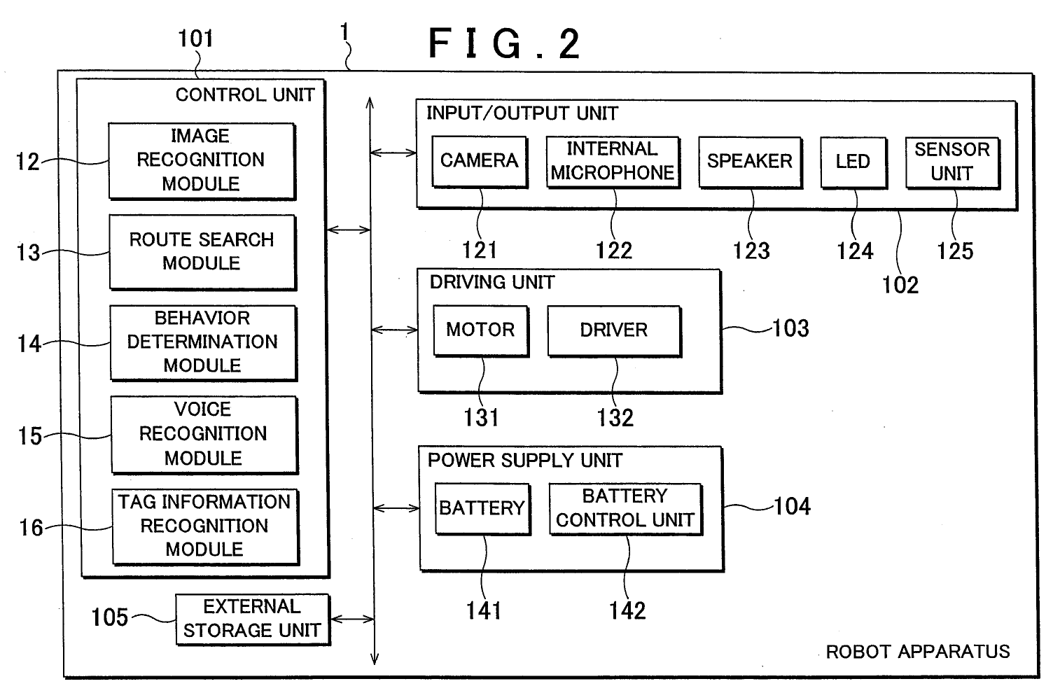

FIG. 2 is a block diagram showing the robot according to this embodiment. The robot 1 includes a control unit 101, an input/output unit 102, a driving unit 103, a power supply unit 104, an external storage unit 105, and so on.

The input/output unit 102 includes a camera 121 constituted by a Charge Coupled Device (CCD) or the like for obtaining images of the peripheral area, one or a plurality of built-in microphones 122 for collecting peripheral sounds, a speaker 123 for outputting a voice in order to interact with a user or the like, a Light Emitting Diode (LED) 124 for expressing responses to the user, emotions, and so on, a sensor unit 125 constituted by a touch sensor or the like, and so on.

The driving unit 103 includes a motor 131, a driver 132 for driving the motor, and so on, and operates the leg portion unit 1d and the arm portion unit 1b in accordance with user instructions or the like. The power supply unit 104 includes a battery 141 and a battery control unit 142 for controlling charge/discharge thereof, and supplies power to each unit.

The external storage unit 105 is constituted by a detachable Hard Disk Drive (HDD), an optical disk, a magneto-optical disk, or the like, which stores various programs, control parameters, and so on, and supplies these programs and data to internal memory (not shown) or the like of the control unit 101 as needed.

The control unit includes a Central Processing Unit (CPU), Read Only Memory (ROM), Random Access Memory (RAM), a wireless communication interface, and so on, and controls various actions of the robot 1. The control unit 101 also includes modules, that, for example, operate in accordance with a control program stored in the ROM, such as an image recognition module 12 for analyzing an image obtained by the camera 121, a route search module 13 for performing a route search on the basis of an image recognition result, a behavior determination module 14 for selecting a behavior to be taken on the basis of various recognition results, a voice recognition module 15 for performing voice recognition, a tag information recognition module 16 for recognizing tag information and the like, and so on. In this embodiment in particular, a word network (knowledge network) is generated by the behavior determination module 14 by modularizing input information into a single information space using information from the tag information recognition module 16 and image recognition module 12, and so on. By generating a behavior using the word network, actions can be expressed in a more natural manner.

The robot 1 according to this embodiment is installed with a behavior determination module (behavior determination apparatus) which, upon reception of instruction information from a human, determines a behavior by extracting words having a close relationship to the instruction information from past instruction information. Thus, even when the instruction information from the person is insufficient, the behavior intended by the instructor can be determined accurately. The behavior determination apparatus installed in the robot apparatus will now be described in detail.

Note that here, a behavior determination module is described as the behavior determination apparatus, but the processing of each block may be realized by causing the CPU to execute a computer program. In this case, the computer program may be stored on a recording medium or transmitted via the Internet or another transmission medium. Further, the newest version of the knowledge network that is enlarged, updated, and so on may be obtained over the Internet or the like.

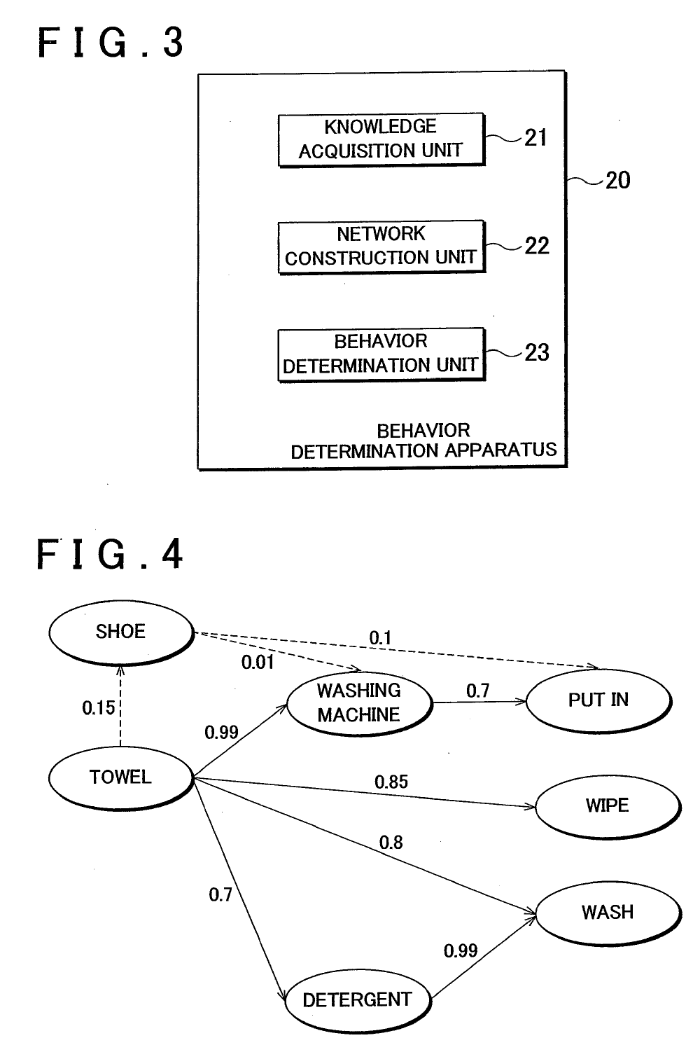

FIG. 3 is a view showing the behavior determination apparatus according to this embodiment. A behavior determination apparatus 20 according to this embodiment extracts words included in the instruction information from a human, stores/accumulates the words, and weights the relationships between the words on a network. Upon reception of instruction information, the behavior determination apparatus 20 determines a behavior on the basis of the weighted network. To realize this, the behavior determination apparatus 20 includes a knowledge acquisition unit 21, a network construction unit 22, and a behavior determination unit 23.

The knowledge acquisition unit 21 extracts words included in instruction information from an external source such as a user (knowledge acquisition function). The instruction information may take the form of voice information such as “wash the towel”, an image recognition result of a towel held in the hand of the user, and so on.

The network construction unit 22 stores/accumulates the words (accumulation function) and weights the relationships between the words on a network. Hereafter, this network will be referred to as a word network. In this case, for example, correct cases and incorrect cases are input from the exterior, and the relationships between the words are learned. The word weighting of the word network in a correct case is increased by 0.01 to 0.1, for example, every time the word is input, and the word weighting of the word network in an incorrect case is reduced by 0.01 to 0.1, for example. An initial value of the word weighting in the word network may be set at 0.5 or the like, for example.

Upon reception of instruction information from a user, the behavior determination unit 23 determines a behavior by extracting words having a close relationship to the instruction information from the word network, which serves as past information. Since the behavior is determined by extracting words having a close relationship from the word network, the behavior intended by the instructor can be determined accurately even when the instruction information provided by the user is insufficient.

To be able to execute various tasks, the robot must learn the various tasks and accumulate experience thereof autonomously. In this embodiment, similarly to a human developmental process, the robot is exposed to various experiences and associates knowledge autonomously using the knowledge accumulated from these experiences. Thus, the robot is able to make inferences in relation to tasks that it has not experienced.

The behavior determination apparatus according to this embodiment will now be described in further detail. In the cognitive development of a human being, the accumulation and storage of experience and the referencing of this accumulated experience from storage is the most basic form of intelligent reasoning capacity. The intelligent determination system of the robot is constructed by emulating this structure. The behavior determination apparatus (behavior determination module) is installed with the following functions.

(1) Brief knowledge/experience acquisition function: the knowledge acquisition unit 21 obtains brief (word-level) knowledge from conditions. In this case, the human teaches the robot correct cases and incorrect cases, whereby knowledge is acquired. By teaching correct and incorrect cases, the reflection of empirical value to the word network can be converged more quickly. For example, “towel”, “washing machine”, “shoe”, and so on are obtained on an index level (without including concepts) in the form of: put the towel into the washing machine→Y; wipe it with the towel→Y; wash the towel→Y; put the shoes into the washing machine→N; put the towel into the shoes→N, and relationships therebetween are expressed.

(2) Network construction function: an accumulated knowledge base is constructed, and a categorized knowledge base is learned (experience base). In this embodiment, it is assumed that the movement of the robot is symbolized (abstracted). Moreover, it is assumed that appearing objects have been recognized and indexed.

The brief knowledge acquired in (1) is accumulated, and a network is constructed on the basis of connections between the accumulated brief knowledge. By inputting similar instruction information repeatedly and so on, the network is converged to a certain level. For example, when a weighting of the word network reaches or exceeds 0.99, updating of the weightings between the corresponding words is stopped. Further, when a weighting falls to or below 0.1, updating of the weightings between the corresponding words is stopped. As a result, the network is categorized using experience information collected without meaning and the connections therebetween. Further, newly added information is converged into the actual word network using the categories as a base. As a result, an instruction from the user to “put the towel into the washing machine and wash it with detergent” generates a new connection (washing machine—detergent) that was not present in (1).

(3) Knowledge extraction: the behavior determination unit 23 has an inference (determination) function for solving problems. An inference relating to insufficient information for executing a task is made from the word network, which is converged continuously through the learning and experience accumulation of (2). Ex. 1) Inference function: in relation to an instruction from a human to “wash the towel”, the robot infers information that is missing from the instruction, such as “washing machine” and “detergent”, and outputs the behavior “wash the towel in the washing machine using detergent” as a result. Ex. 2) Error prevention function: in relation to the instruction “wash the leather shoes in the washing machine”, the weighting between the words “shoe” and “washing machine” is small, and therefore the fact that shoes must not be washed in the washing machine is held in the knowledge base. Hence, the robot does not carry out the behavior immediately, and instead checks with the human whether or not the leather shoes are to be washed in the washing machine, for example.

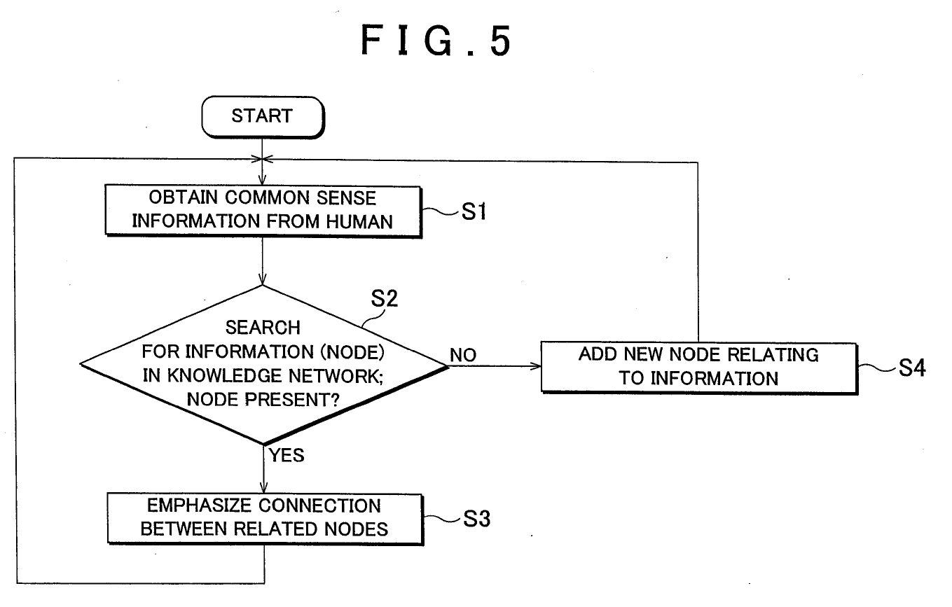

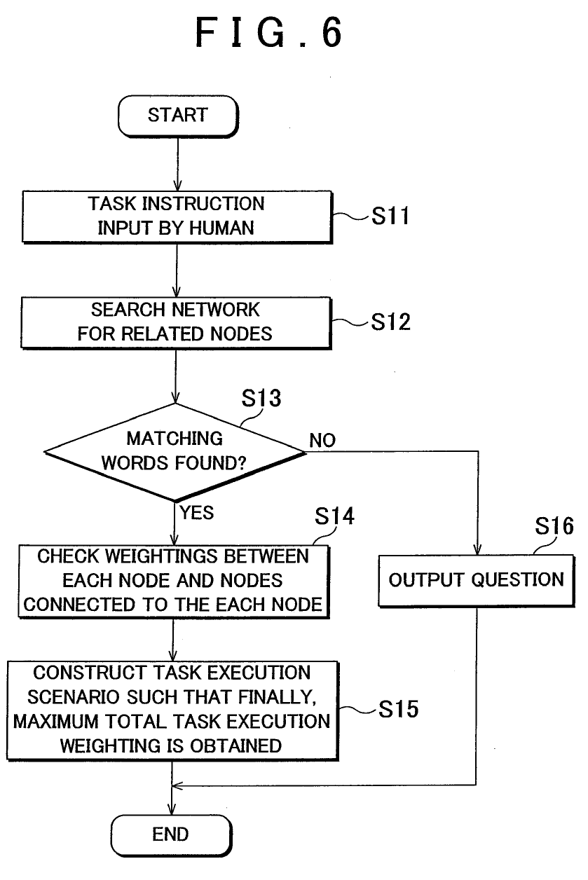

Next, an operation of the behavior determination apparatus according to this embodiment will be described. FIG. 4 is a view showing a word network according to this embodiment. FIG. 5 is a flowchart showing a word network construction method according to this embodiment. FIG. 6 is a flowchart showing a behavior determination method according to this embodiment. First, a method used by the robot apparatus to construct a word network such as that shown in FIG. 4 will be described. The word network is formed from connections (relationships) between words and numerical values corresponding to the strength of the connections (relationships) between the words. In the example in FIG. 4, the weighting between the words “towel” and “shoe” is 0.15, and therefore the relationship between these two words is weak, whereas the weighting between the words “towel” and “washing machine” is 0.99, and therefore the relationship between these two words is strong.

To construct this type of word network, the knowledge acquisition unit 21 in the behavior determination apparatus 20 of the robot 1 obtains common sense information from a human (step S1). As noted above, this information includes “put the towel in the washing machine”, “wipe it with the towel”, “wash the towel”, “put the shoes into the washing machine”, “put the towel into the shoes”, and so on, and accordingly, words such as “towel”, “washing machine”, “wipe”, “wash”, and “shoe” are extracted.

Next, the network construction unit 22 searches the current word network to determine whether or not the corresponding words are included (step S2). In the example shown in FIG. 4, all of the words are registered (step S2: Yes), and therefore, assuming that the related words, for example towel-washing machine, towel-wipe, and towel-wash, are closely related, the weightings between these nodes are updated in an increasing direction. When an extracted word does not exist in the network, on the other hand, a new word node is added and the weightings between the new word and the other words are set at the initial value. Setting may be performed here such that when the weighting indicating the relationship between words reaches or exceeds a fixed value and falls to or below a fixed value, updating of the weighting is stopped. As shown in FIG. 4, for example, the weighting of towel-washing machine is 0.99 and the weighting between shoe-towel is 0.15, and in such cases, i.e. when the weighting reaches or exceeds 0.99 or falls to or below 0.15, for example, updating of the weighting may be stopped. In so doing, unnecessary learning is eliminated.

Next, behavior generation will be described. First, a task instruction is received from the user (step S11). The behavior determination unit 23 then searches the word network for matching or similar words to the words included in the task (step S12). When a matching word is found (step S13: Yes), the weightings between the word and adjacent nodes are checked (step S14). The word having the largest weighting is then selected together with the word having the largest weighting of the words connected to the selected word. By repeating this processing, words are extracted gradually such that finally, a maximum total task execution weighting is obtained (step S15).

For example, when the user says “towel”, the words towel-washing machine-detergent-wash are extracted from the word network shown in FIG. 4, and accordingly the robot can ask the user a question such as “Should I wash the towel in the washing machine using detergent?”

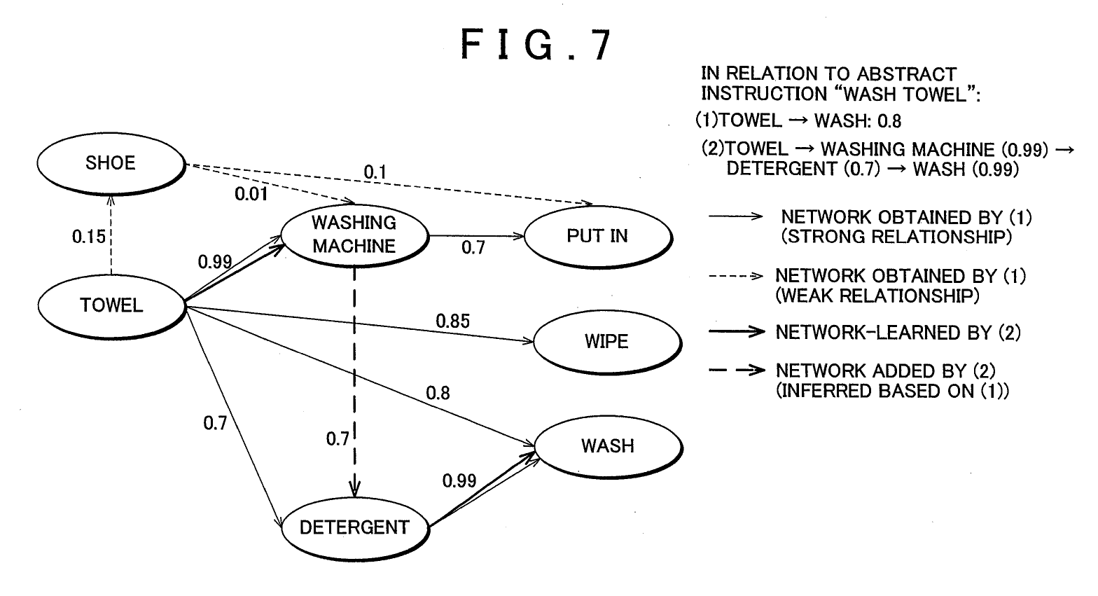

FIG. 7 is a view illustrating a method of using the word network. For example, when the user issues an abstract instruction such as “Wash the towel”, the robot generates a behavior in accordance with the respective weightings between the words. Here, 1) towel→wash (0.8) and 2) towel→washing machine (0.99)→detergent (0.7)→wash (0.99) are established, and therefore 2) has a greater weighting (average, for example) from “towel” to “wash” than 1). In this case, 2) is selected as the result of the final inference.

On the other hand, when a provided word is not included in the word network, for example when the user says “bet”, the robot responds to the user with a question such as “What should I do?” (step S16), and thus incorrect actions are prevented. In other words, the robot may include a behavior confirmation unit for confirming with the user that the behavior determined by the behavior determination unit 23 is correct after the behavior is output. Thus, the user can teach the robot the correct behavior. In this case, the network construction unit 22 updates the weightings of the word network on the basis of the confirmation result obtained by the behavior confirmation unit. Thus, the word network can be updated in accordance with the teaching of the user. The network construction unit 22 is also capable of updating or enlarging the word network on the basis of recognition information provided externally or detected by the sensor unit 125. The network construction unit 22 is capable of generating a comprehensive intelligence network by connecting a network constructed from the recognition information (sensor information) to the word network, for example. As a result, the robot can express behavior that is even more varied.

Further, “towel”, “detergent”, and so on are used as the nodes of the word network, but similar words to the respective nodes may be registered in each node, and a thesaurus or the like may be prepared. For example, assuming that “handkerchief” is a similar word to “towel”, when the user presents a handkerchief, the robot can use the network shown in FIG. 4 to determine that the handkerchief is to be washed in the washing machine with detergent.

In this embodiment, a word network is constructed from correct cases and incorrect cases taught by the user, and the word network is used to determine a behavior. When incorrect cases are taught in addition to correct cases, the reflection of empirical value to the word network can be converged more quickly. Further, when the word network is used, an action not included in the user instruction can be inferred. Moreover, by storing a large amount of associated information in a network, large numbers of words and behaviors can be gathered in a single information space, and therefore actions and reactions employing complicated information can be generated. Furthermore, the robot collects information for executing a task autonomously in response to an incomplete task instruction from a human, and therefore the task instructions issued to the robot by the human can be simplified.

Note that the invention is not limited to the above embodiment alone, and may of course be subjected to various modifications within a scope that does not depart from the spirit of the invention.

What is claimed is:

1. A behavior determination apparatus comprising:
a word extraction unit for extracting words from external instruction information;
a behavior determination unit for determining a behavior on the basis of a word network in which relationships between words are weighted on a network, and the words extracted by the word extraction unit.

2. The behavior determination apparatus according to claim 1, wherein the behavior determination unit generates a behavior by extracting words from the network successively in order of a weighting thereof.

3. The behavior determination apparatus according to claim 1, further comprising a behavior confirmation unit for confirming with a user that the behavior determined by the behavior determination unit is correct after the behavior has been output.

4. The behavior determination apparatus according to claim 3, further comprising a network updating unit for updating the weightings of the word network on the basis of a confirmation result obtained by the behavior confirmation unit.

5. The behavior determination apparatus according to claim 4, wherein the network updating unit generates a comprehensive intelligence network in which recognition information provided externally or detected by a detecting unit is associated with the words in the word network.

6. A behavior learning apparatus comprising:
a word extraction unit for extracting words from external instruction information; and
a network construction unit for constructing a network in which words are associated by weightings on the basis of the words extracted by the word extraction unit and relationships therebetween, and updating the weightings between the words on the basis of the instruction information.

7. The behavior learning apparatus according to claim 6, wherein the word extraction unit inputs correct instruction information and incorrect instruction information, and
the network construction unit increases the weighting between words extracted from the correct instruction information and reduces the weighting between words extracted from the incorrect instruction information.

8. The behavior learning apparatus according to claim 6, wherein the network construction unit stops updating the weighting between the words when the weighting reaches or exceeds a predetermined first value or falls to or below a predetermined second value.

9. A behavior determination method comprising:
a word extraction step of extracting words from external instruction information; and
a behavior determination step of determining a behavior on the basis of a word network in which relationships between words are weighted on a network, and the words extracted in the word extraction step.

10. The behavior determination method according to claim 9, wherein, in the behavior determination step, a behavior is generated by extracting words from the network successively in order of a weighting thereof.

11. A behavior learning method comprising:
a word extraction step of extracting words from external instruction information; and
a network construction step of constructing a network in which words are associated by weightings on the basis of the words extracted in the word extraction step and relationships therebetween, and updating the weightings between the words on the basis of the instruction information.

12. The behavior learning method according to claim 11, wherein, in the word extraction step, correct instruction information and incorrect instruction information are input, and
in the network construction step, the weighting between words extracted from the correct instruction information is increased and the weighting between words extracted from the incorrect instruction information is reduced.

13. The behavior learning method according to claim 11, wherein, in the network construction step, updating of the weighting between the words is stopped when the weighting reaches or exceeds a predetermined first value or falls to or below a predetermined second value.

14. A robot apparatus for expressing an action in accordance with an external instruction, comprising:
a word extraction unit for extracting words from external instruction information; and
a behavior determination unit for determining a behavior on the basis of a word network in which relationships between words are weighted on a network, and the words extracted by the word extraction unit.

15. The robot apparatus according to claim 14, further comprising a network construction unit for constructing a network from the extracted words and updating weightings between the words.

16. A robot apparatus comprising:
a word extraction unit for extracting words from external instruction information; and
a network construction unit for constructing a network in which words are associated by weightings on the basis of the words extracted by the word extraction unit and relationships therebetween, and updating the weightings between the words on the basis of the instruction information.

17. A medium recorded with a program for causing a computer to execute a predetermined operation, the program comprising:
a word extraction step of extracting words from external instruction information; and
a behavior determination step of determining a behavior on the basis of a word network in which relationships between words are weighted on a network, and the words extracted in the word extraction step.

18. A medium recorded with a program for causing a computer to execute a predetermined operation, the program comprising:
a word extraction step of extracting words from external instruction information; and
a network construction step of constructing a network in which words are associated by weightings on the basis of the words extracted in the word extraction step and relationships therebetween, and updating the weightings between the words on the basis of the instruction information.
